(19) United States
(12) Patent Application Publication
(10) Pub. No.: US 2026/0151867 A1
(43) Pub. Date: Jun. 4, 2026

(54) METHOD FOR OPERATING A MECHANICAL PRODUCTION PLANT, AND MECHANICAL PRODUCTION PLANT

(71) Applicant: TRUMPF Werkzeugmaschinen SE + Co. KG, Ditzingen (DE)

(72) Inventors: Rene Harig, Elsterheide (DE); Dominik Straus, Esslingen-Zell (DE)

(21) Appl. No.: 19/464,661

(22) Filed: Jan. 30, 2026

Related U.S. Application Data
(63) Continuation of application No. PCT/EP2023/071546, filed on Aug. 3, 2023.

(51) Int. Cl. B23Q 7/10; B23Q 7/14

(52) U.S. Cl. CPC B23Q 7/106; B23Q 7/1426

(57) ABSTRACT

A method for operating a plant, including providing a number of pallets required for a production process for a pallet storage unit and transferring the pallets between a production position and a storage position. The pallets are stored in the storage position on supports of storage locations in each case and define the storage height of a respective storage location. The method includes configuring a storage unit by the pallets adapted to the production process carried out on a mechanical production device. A new configuration of the storage unit is carried out. A pallet supply is provided to which pallets are transferred that are required for an existing configuration and not required for a new configuration, and/or from which pallets stored in the pallet supply are removed that are required for the new configuration in addition to the pallets required for the existing configuration.

### CROSS REFERENCE TO RELATED APPLICATIONS

This application is a continuation of International Application No. PCT/EP2023/071546 (WO 2025/026561 A1), filed on Aug. 3, 2023, which is hereby incorporated by reference herein.

### FIELD

The invention relates to a method for operating a mechanical production plant and to a mechanical production plant designed to carry out the method.

### BACKGROUND

EP 1 930 119 A1 relates to a mechanical plant comprising a workpiece storage designed as a pallet storage, several mechanical machining units for workpiece machining and a mechanical loading device. The mechanical loading device picks up storage pallets loaded with workpieces to be machined from a storage rack of the workpiece storage and then feeds them to the mechanical machining units. After the workpiece machining is completed, the storage pallets loaded with machining products are transported back to the storage rack of the workpiece storage by means of the mechanical loading device and stored there if required.

### SUMMARY

In an embodiment, the present disclosure provides a method for operating a mechanical production plant with a mechanical production device on which workpieces are machined in a production process by producing machining products from starting workpieces, and a pallet storage unit having a storage rack and storage pallets. The storage rack has pairs of adjacent rack stringers spaced apart in a horizontal direction, as well as pallet storage locations that are adjacent to one another in a vertical direction and that are formed by providing pallet supports on adjacent rack stringers of a pair of the pairs of rack stringers, the pallet supports being located opposite one another at a mutual distance in the horizontal direction. The method comprises providing a number of storage pallets that is required for the production process for the pallet storage unit and transferring the storage pallets between a production-side position located towards the production device and a storage-side position. The storage pallets are stored in the storage-side position on the pallet supports of the pallet storage locations in each case and define the storage height of a respective pallet storage location as a clear vertical distance between two storage pallets that are adjacent to each other in the storage-side position in the vertical direction or as the clear vertical distance between a respective storage pallet and another boundary of the respective pallet storage location that is adjacent to it in the vertical direction. The method comprises configuring the pallet storage unit by the storage pallets in a manner adapted to the production process carried out on the mechanical production device. A new configuration of the pallet storage unit is carried out by changing an existing configuration of the pallet storage unit by changing a storage height of at least one of the pallet storage locations by changing the number of storage pallets of the pallet storage unit. The method comprises providing a pallet supply to which storage pallets are transferred that are required for the existing configuration of the pallet storage unit and that are not required for the new configuration of the pallet storage unit, and/or from which storage pallets stored in the pallet supply are removed that are required for the new configuration of the pallet storage unit in addition to the storage pallets required for the existing configuration of the pallet storage unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a mechanical production plant for sheet metal production in a plan view, with a laser flatbed machine, a pallet storage unit, a pallet transfer device and an external pallet supply;

FIG. 2 illustrates a perspective view of a pallet storage unit of the type shown in FIG. 1; and

FIG. 3 and FIG. 4 illustrate configurations and new configuration options for a pallet storage unit according to FIGS. 1 and 2.

### DETAILED DESCRIPTION

In an embodiment, the present disclosure enables continuous and trouble-free operation of generic mechanical production plants, regardless of the production process carried out.

In the case of the present disclosure, the pallet storage unit is configured in a manner adapted to the production process carried out on the mechanical production device by adjusting the available storage height of the pallet storage locations and/or the total available storage height of the storage rack of the pallet storage unit as required. For this purpose, the number of storage pallets transferred between the storage rack of the pallet storage unit and the production device to carry out the production process is adapted to the respective production process. According to the present disclosure, a pallet supply is provided for storage pallets that are no longer required due to the completed production process or are additionally required. Storage pallets that are no longer required for process reasons are transferred to the pallet supply. Additional storage pallets required due to the production process are taken from the pallet supply.

In the case of the present disclosure, the pallet supply can be integrated into the storage rack of the pallet storage unit. In order for the pallet supply to block as little storage height as possible on the storage rack, the vertical distance between two storage pallets adjacent to each other in the pallet supply is preferably smaller than the vertical distance that two storage pallets provided for carrying out a production process have in the storage-side position on the storage rack of the pallet storage unit.

In an embodiment of the present disclosure, the pallet supply is provided away from the storage rack of the pallet storage unit. A reduction in the total storage height available on the storage rack due to temporarily unused storage pallets is avoided in this embodiment of the present disclosure.

According to the present disclosure, the configuration of the pallet storage unit can be adapted to the production process carried out on the production device during the ongoing production process and/or after completion of a production process and before the start of a new production process.

In both cases, the trigger for a new configuration of the pallet storage unit is a change in the requirement for the storage height available at the individual storage locations of the storage rack and/or at the storage rack as a whole, due to the production process.

For example, as a production process progresses and/or as a production process follows a completed production process, the need for storage height to accommodate output workpieces can decrease and the need for storage height to accommodate machining products can increase.

For example, in the separating and forming of starting workpieces, such as raw metal sheets, the height of a stack of starting workpieces placed on a storage pallet used as a raw parts pallet is often significantly lower than the height of the stack of the machining products produced from these starting workpieces.

During the ongoing production process, as the machining of the starting workpieces progresses, the number of raw parts pallets stored on the storage rack decreases and thus the need for pallet storage locations where only a relatively low storage height is sufficient. At the same time, the number of product pallets loaded with machining products increases and thus the need for storage spaces with relatively large storage heights increases as well. As part of the new configuration of the pallet storage unit adapted to the production process, in the case of the present disclosure, storage height is freed up during the ongoing production process by reducing the number of storage pallets on the storage rack, which was previously blocked by the storage pallets transferred to the pallet supply and which is available as storage height for machining products after the reduction of the number of storage pallets.

In order to optimize the time required for workpiece machining on the production plant according to the present disclosure, it is recommended to make maximum use of the load-bearing capacity of the storage pallets and/or the pallet storage locations on the storage rack of the pallet storage unit. At maximum loading, the number of storage pallets which must be transferred between the pallet storage unit and the mechanical production device to carry out the production process is reduced to a minimum. However, the maximum loading height of a storage pallet can vary depending on the starting workpieces and machining products placed on the storage pallet.

Additionally or alternatively, in an embodiment of the present disclosure, use is made of newly configuring the pallet storage unit during the ongoing production process and/or after completion of a production process in the event of a change in the material of the starting workpieces to be machined.

The material of the starting workpieces is decisive for the maximum loading height of the storage pallet and thus also for the storage height of the pallet storage location for the storage pallet, given the load-bearing capacity of a storage pallet and/or given the load-bearing capacity of the pallet supports of a storage pallet. This applies equally to raw parts pallets and product pallets.

If, for example, aluminum workpieces are machined on the mechanical production device following the machining of steel starting workpieces, the number of starting workpieces and also the maximum number of machining products that can be stacked on a storage pallet arranged in a storage location can be increased significantly. This means that a significantly greater storage height can be provided at a storage location of the storage rack for accommodating a storage pallet loaded with starting workpieces or machining products made of aluminum than was previously available for accommodating a storage pallet loaded with starting workpieces or machining products made of steel. In the case of the present disclosure, this is achieved by arranging storage pallets that were previously loaded with steel starting workpieces and that are no longer required for the aluminum starting workpieces that are now to be machined, closely stacked in the pallet supply provided on the storage rack or by transferring them from the storage rack to the external pallet supply. Due to the reduction in the number of storage pallets, the new configuration of the pallet storage unit advantageously results in an increase in the total storage height available on the storage rack for starting workpieces and/or for machining products and thus an increase in the storage capacity of the storage rack.

In an embodiment of the present disclosure, the storage pallets have a uniform design so that one and the same storage pallet can be used both as a raw parts pallet and as a product pallet.

The transfer of surplus storage pallets to the pallet supply and/or the removal of additionally required storage pallets from the pallet supply can be done manually.

In an embodiment of the present disclosure, a mechanical pallet transport device is provided for this purpose. In automated production plants, automated guided vehicles (AGVs) are particularly suitable as mechanical pallet transport devices.

In cases where the production plant according to the present disclosure has an external pallet supply, the pallet transfer device comprises a rack-side transfer unit and a production-side transfer unit, which simultaneously forms the pallet transport device.

In order to automate the method according to the present disclosure and the production plant according to the present disclosure, a programmable numerical control is provided for the pallet transfer device and/or for the pallet transport device. In an embodiment of the present disclosure, the programmable numerical control for the pallet transfer device and/or for the pallet transport device is integrated into a higher-level numerical plant control system of the production plant according to the present disclosure. The configuration or new configuration of the pallet storage unit can then be automatically adjusted to the parameters stored in the plant control system of a production process to be carried out on the mechanical production plant.

Embodiments of the present disclosure will be explained in more detail below on the basis of exemplary schematic illustrations.

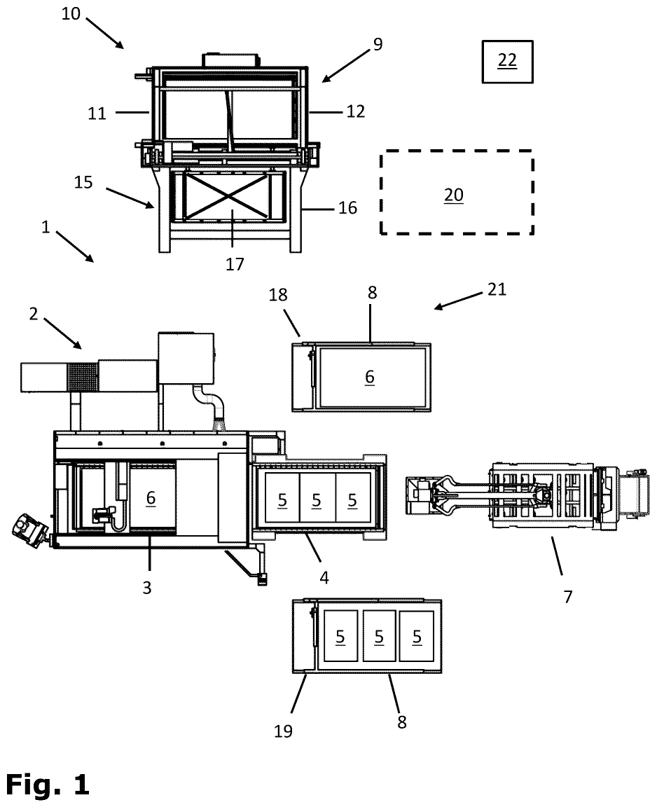

According to FIG. 1, a mechanical production plant 1 for sheet metal production comprises, as a mechanical production device, a conventional laser flatbed machine 2 for separating sheet metal fabrication. A pallet changer 4 is arranged in the usual way in front of a working area 3 of the laser flatbed machine 2. On its upper side, the pallet changer 4 in FIG. 1 stores three finished sheet metal parts 5 as machining products of a sheet metal fabrication carried out on the laser flatbed machine 2. Inside the working area 3 of the laser flatbed machine 2, a raw metal sheet 6 undergoes separative machining as the starting workpiece.

A mechanical handling device 7 of conventional design is provided for loading and unloading the pallet changer 4.

By means of the handling device 7, finished sheet metal parts 5 produced from a raw metal sheet 6 are picked up at the pallet changer 4 and placed on a storage pallet 8 arranged below the pallet changer 4 in FIG. 1 and forming a product pallet.

On the opposite side of the pallet changer 4, FIG. 1 shows a storage pallet 8 loaded with raw metal sheets 6 and thus serving as a raw parts pallet.

After unloading the pallet changer 4 and after depositing the finished sheet metal parts 5 on the lower storage pallet 8 in FIG. 1, the handling device 7 picks up a raw metal sheet 6 on the upper storage pallet 8 in FIG. 1 and loads the pallet changer 4 with it.

The storage pallet 8 loaded with the raw metal sheets 6 was previously removed from a storage rack 9 of a pallet storage unit 10 of the production plant 1.

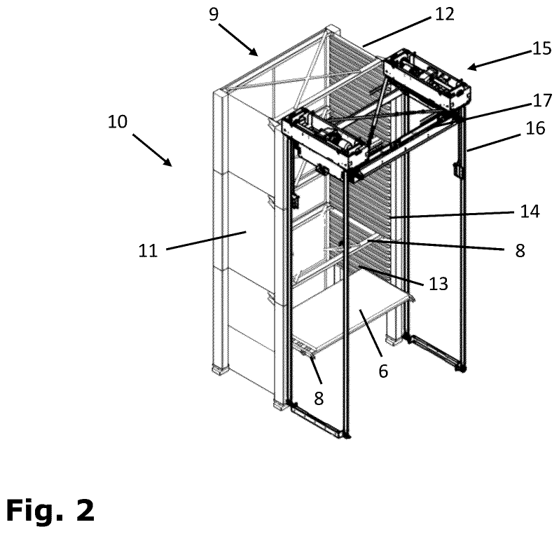

The storage rack 9 has a pair of rack stringers with two rack stringers 11, 12 adjacent to each other at a mutual distance in the horizontal direction. As shown in FIG. 2, pallet storage locations 13 are formed inside the storage rack 9 by attaching support and guide rails 14 to the rack stringers 11, 12, which form pallet supports. In FIG. 2, only the support and guide rails 14 on the rack stringer 12 are visible. The support and guide rails 14 of the rack stringer 12 are opposite support and guide rails 14 attached to the rack stringer 11 and concealed in FIG. 2 at a horizontal distance.

In FIG. 2, only two storage pallets 8 are shown on the storage rack 9 for the sake of clarity. Raw metal sheets 6 are stacked on the lower storage pallet 8. Of the upper storage pallet 8 in FIG. 2, only the frame equipped with guide rollers is shown. When storing and retrieving the storage pallets 8 on the storage rack 9, the guide rollers of the storage pallets 8 roll on the support and guide rails 14 of the relevant pallet storage location 13.

A conventional pallet lift 15 is used for the automated storage and retrieval of storage pallets 8 on the storage rack 9.

A loading and unloading unit 17 is movable in a driven manner in the vertical direction in the usual manner on a support frame 16 of the pallet lift 15. In order to retrieve a storage pallet 8, the loading and unloading unit 17 of the pallet lift 15 moves vertically to the height of the relevant pallet storage location 13. The storage pallet 8 to be unloaded is then pulled from the storage rack 9 onto the loading and unloading unit 17 of the pallet lift 15. For storage on the storage rack 9, the storage pallet 8 to be stored is pushed by the loading and unloading unit 17 arranged at the level of the respective pallet storage location 13 onto the support and guide rails 14 of the respective pallet storage location 13 attached to the rack stringers 11, 12.

The pallet lift 15 forms a rack-side transfer unit of a pallet transfer device 21. In addition to the pallet lift 15, the pallet transfer device 21 comprises a production-side transfer unit with two automated guided vehicles (AGVs) 18, 19 (FIG. 1).

In FIG. 1, the transport vehicle 18 is loaded with the storage pallet 8 intended as a raw parts pallet and the raw metal sheets 6 placed thereon. The storage pallet 8 with the raw metal sheets 6 was previously removed from the storage rack 9 of the pallet storage unit 10 by means of the pallet lift 15 and placed in a transfer position on the transport vehicle 18.

The transport vehicle 19 in FIG. 1 stores the storage pallet 8 intended as a product pallet with the finished sheet metal parts 5. As soon as the entire metal sheet stack of the storage pallet 8 loaded with the raw metal sheets 6 has been processed by means of the laser flatbed machine 2 and the finished sheet metal parts 5 produced in this way have been placed on the storage pallet 8 provided as a product pallet on the transport vehicle 19, the transport vehicle 19 moves together with the storage pallet 8 loaded with the finished sheet metal parts 5 to the storage rack 9. There, the storage pallet 8 loaded with the finished sheet metal parts 5 is taken over by the pallet lift 15 arranged in the transfer position and then stored on the storage rack 9. The transport vehicle 19 is then loaded by means of the pallet lift 15 with a storage pallet 8 on which raw metal sheets 6 are stacked.

Meanwhile, the transport vehicle 18, now loaded with an empty storage pallet 8, changes from the position shown in FIG. 1 above the pallet changer 4 to the position below the pallet changer 4, which has since been vacated by the transport vehicle 19.

The transport vehicle 19 loaded with the raw parts pallet and the raw metal sheets 6 stacked thereon moves from the transfer position on the storage rack 9 to the laser flatbed machine 2 into the position above the pallet changer 4, which has since been vacated by the transport vehicle 18.

In the manner described above, the raw metal sheets 6 stacked on the storage pallet 8 on the transport vehicle 19 are now subjected to separative machining by means of the laser flatbed machine 2, and the finished sheet metal parts 5 produced in this way are placed on the storage pallet 8, which is now provided as a product pallet, on the transport vehicle 18.

The pallet storage unit 10 of the mechanical production plant 1 can be configured in a manner adapted to the production process carried out on the laser flatbed machine 2. An existing configuration of the pallet storage unit 10 can be changed if necessary.

Just like the other essential functions of the production plant 1, the configuration of the pallet storage unit 10 is also controlled by means of a programmable numerical control 22 of the production plant 1.

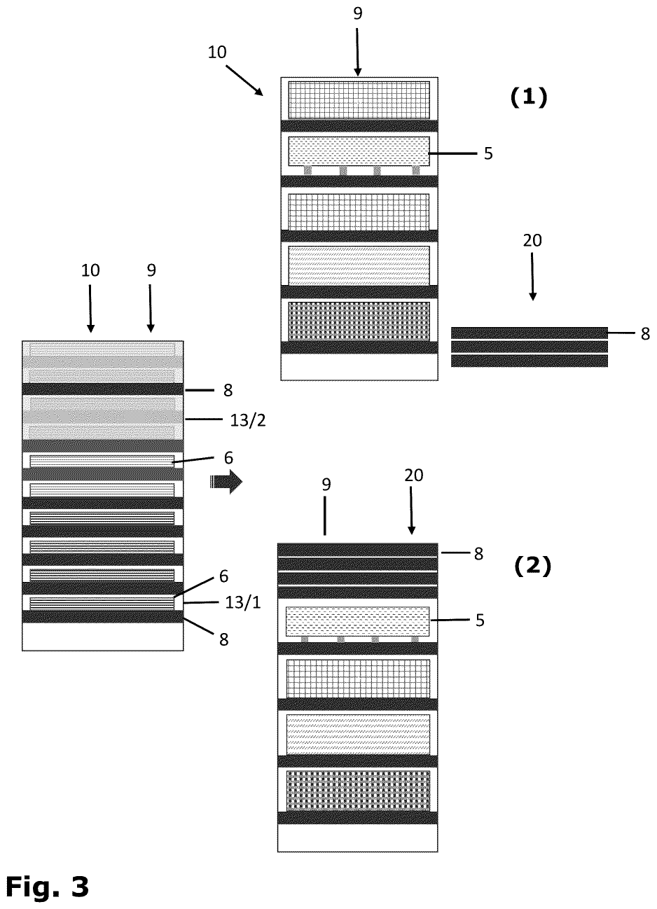

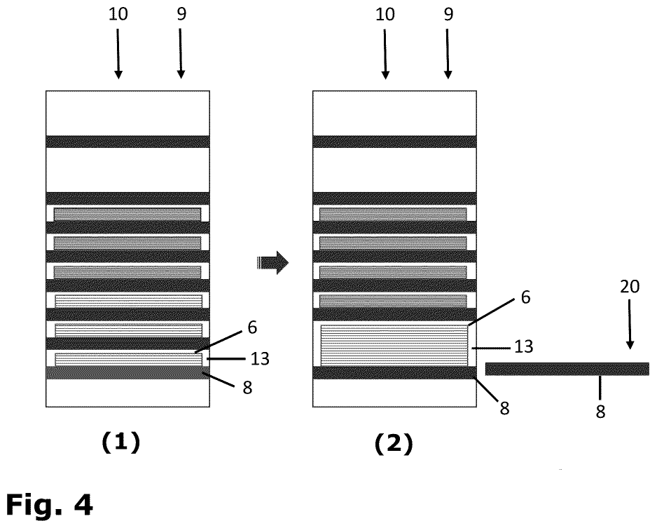

Examples of configurations and new configurations of the pallet storage unit 10 are illustrated in FIGS. 3 and 4.

According to the left partial illustration of FIG. 3, before the start of a separating sheet metal fabrication on the laser flatbed machine 2, six storage locations 13/1 on the storage rack 9 of the pallet storage 10 are occupied by storage pallets 8 with raw metal sheets 6 (raw parts pallets).

Above the pallet storage locations 13/1 for raw metal sheets 6, two storage locations 13/2 for finished sheet metal parts 5 are provided, which at the time shown are occupied with still unloaded storage pallets 8 (product pallets).

A total of eight storage pallets 8 were therefore provided for the upcoming production process.

For the new configuration of the pallet storage unit 10 adapted to the ongoing production process, it should be noted that the finished sheet metal parts 5 produced from the raw metal sheets 6 in the example shown are significantly higher than the raw metal sheets 6. Consequently, at the end of the production process, a total storage height must be available for storing the finished sheet metal parts 5 on the storage rack 9 that is greater than the total storage height of the storage rack 9 at the beginning of the production process, which results from the sum of the storage heights of the pallet storage locations 13/1 and 13/2 in the left partial illustration of FIG. 3.

The resulting additional storage height requirement at the end of the production process is covered (as shown in the two partial representations on the right in FIG. 3), depending on the production process, by reducing the number of storage pallets 8 provided for the production process from an initial total of eight storage pallets 8 to five storage pallets 8 for finished sheet metal parts 5 (new configuration (1) in FIG. 3) or to four storage pallets 8 for finished sheet metal parts 5 (new configuration (2) in FIG. 3).

The storage pallets 8 that are no longer provided for the production process are deposited in a pallet supply 20.

The pallet supply 20 can be provided away from the storage rack 9 (new configuration (1) in FIG. 3). In this case, the removal of storage pallets 8 provided for the production process on the storage rack 9 for finished sheet metal parts 5 frees up storage height that was originally blocked by the storage pallets 8 now transferred to the pallet supply 20.

Alternatively, the pallet supply 20 can be integrated into the storage rack 9 (new configuration (2) in FIG. 3). In this context, the increase in storage height on the storage rack 9 results from the fact that the storage pallets 8 are arranged directly above one another in the pallet supply 20 and therefore block less storage height on the storage rack 9 than at the beginning of the production process.

For the transport of storage pallets 8 to the pallet supply 20, the transport vehicles 18, 19 are used, which accordingly serve as pallet transport devices in addition to their function as production-side transfer units of the pallet transfer device 21. When the pallet supply 20 is integrated into the storage rack 9, the storage pallets 8 that are no longer provided for the production process are unloaded from the transport vehicles 18, 19 by means of the pallet lift and deposited in the pallet supply 20.

FIG. 4 shows a case in which a new configuration of the pallet storage unit 10 is carried out after completion of a production process on the laser flatbed machine 2 and before the start of the next production process because the material of the raw metal sheets 6 to be machined changes.

In the application case illustrated in FIG. 4, both raw metal sheets 6 made of steel and raw metal sheets 6 made of aluminum are machined in an upcoming production process.

In the case of the configuration (1) of the pallet storage unit 10, the three upper loaded storage pallets 8 on the storage rack 9 store raw metal sheets 6 made of steel, the three storage pallets 8 arranged below are loaded with raw metal sheets 6 made of aluminum. All pallet storage locations 13 of the storage rack 9 occupied by loaded storage pallets 8 have the same storage height. This circumstance is disadvantageous in that the maximum load-bearing capacity of the storage pallets 8 loaded with raw metal sheets 6 made of steel is exhausted, but not the maximum load-bearing capacity of the storage pallets 8 loaded with raw metal sheets 6 made of aluminum. The consequence is that in order to process the raw metal sheets 6 made of aluminum, more storage pallets 8 than actually necessary have to be unloaded from the storage rack 9 and transferred to the laser flatbed machine 2.

In order to avoid this disadvantage, the configuration (1) of the pallet storage unit 10 is changed to the configuration (2). For this purpose, a storage pallet 8, which is provided for the production process in the configuration (1), is deactivated and deposited in an external pallet supply 20. This frees up storage height on the storage rack 9, which in the configuration (1) was blocked by the now deactivated storage pallet 8 and which in the case of the configuration (2) is used to accommodate additional raw metal sheets 6.

The configuration (2) of the pallet storage unit 10 is optimized compared to the configuration (1) in that in the case of the configuration (2) the maximum load-bearing capacity of the respective storage pallet 8 is also utilized when storing the raw metal sheets 6 made of aluminum. Due to their lower weight, raw metal sheets 6 made of aluminum allow for a greater storage height of a pallet storage location 13 than raw metal sheets 6 made of steel.

In the configuration (2) only a single storage pallet 8 is provided to store the same number of raw metal sheets 6 made of aluminum as in the configuration (1). Accordingly, in the configuration (2), only a single storage pallet 8 has to be unloaded from the storage rack 9 and transferred to the laser flatbed machine 2 to process the raw metal sheets 6 made of aluminum. The result is a significant simplification and acceleration of the execution of the method.

In addition, storage height that was intended for raw metal sheets 6 made of aluminum in the configuration (1) can be used for additional raw metal sheets 6 made of steel in the configuration (2).

In contrast to the example described above, changing the configuration (1) of FIG. 4 into the configuration (2) could also serve to change the material-related purpose of a pallet storage location 13. This would be the case if, in the configuration (1), the two lower pallet storage locations 13 were occupied with raw metal sheets 6 made of steel.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating a mechanical production plant with:
a mechanical production device on which workpieces are machined in a production process by producing machining products from starting workpieces, and
a pallet storage unit having a storage rack and storage pallets,
wherein the storage rack has pairs of adjacent rack stringers spaced apart in a horizontal direction, as well as pallet storage locations that are adjacent to one another in a vertical direction and that are formed by providing pallet supports on adjacent rack stringers of a pair of the pairs of rack stringers, the pallet supports being located opposite one another at a mutual distance in the horizontal direction,
the method comprising:
providing a number of storage pallets that is required for the production process for the pallet storage unit;
transferring the storage pallets between a production-side position located towards the production device and a storage-side position, wherein the storage pallets are stored in the storage-side position on the pallet supports of the pallet storage locations in each case and define the storage height of a respective pallet storage location as a clear vertical distance between two storage pallets that are adjacent to each other in the storage-side position in the vertical direction or as the clear vertical distance between a respective storage pallet and another boundary of the respective pallet storage location that is adjacent to it in the vertical direction;
configuring the pallet storage unit by the storage pallets in a manner adapted to the production process carried out on the mechanical production device, wherein a new configuration of the pallet storage unit is carried out by changing an existing configuration of the pallet storage unit by changing a storage height of at least one of the pallet storage locations by changing the number of storage pallets of the pallet storage unit; and
providing a pallet supply,
to which storage pallets are transferred that are required for the existing configuration of the pallet storage unit and that are not required for the new configuration of the pallet storage unit, and/or
from which storage pallets stored in the pallet supply are removed that are required for the new configuration of the pallet storage unit in addition to the storage pallets required for the existing configuration of the pallet storage unit.

2. The method according to claim 1, wherein the pallet supply is provided away from the storage rack of the pallet storage unit.

3. The method according to claim 1, wherein the new configuration of the pallet storage unit is carried out during an ongoing production process.

4. The method according to claim 1, wherein the new configuration of the pallet storage unit is carried out after completion of the production process for a subsequent production process,
wherein the storage pallets required for the completed production process, which are not required for the subsequent production process, are transferred to the pallet supply and/or wherein storage pallets stored in the pallet supply are removed from the pallet supply, which are required for the subsequent production process in addition to the storage pallets required for the completed production process.

5. The method according to claim 1, wherein the pallet storage unit is configured by the storage pallets in a manner adapted to the production process carried out on the mechanical production device by the storage pallets provided for the production process being intended partly for use as active raw parts pallets for starting workpieces and partly for use as active product pallets for machining products,
wherein pallet storage locations intended for the raw parts pallets and pallet storage locations intended for the product pallets are provided on the storage rack,
wherein the storage height of a pallet storage location intended for a raw parts pallet differs from the storage height of a pallet storage location intended for a product pallet, and
wherein when the pallet storage unit is newly configured, the purpose of this pallet storage location is changed by changing the storage height of a pallet storage location.

6. The method according to claim 1, wherein when the pallet storage unit is newly configured by changing the storage height of a respective pallet storage location, a maximum loading height of a storage pallet arranged at the respective pallet storage location is changed.

7. The method according to claim 1, wherein on the storage rack, pallet storage locations are provided with a storage height, due to which the pallet storage locations have a material-related purpose for the material of the starting workpieces and the machining products, and
wherein when newly configuring the pallet storage unit by changing the storage height of a respective pallet storage location, the material-related purpose of the respective pallet storage location is changed.

8. A mechanical production plant, comprising:
a mechanical production device configured to carry out a production process in the course of which workpieces are machined by producing machining products from starting workpieces;
a pallet storage unit having a storage rack and storage pallets,
wherein the storage rack has pairs of adjacent rack stringers spaced apart in a horizontal direction, as well as pallet storage locations that are adjacent to one another in a vertical direction and that are formed by providing pallet supports on adjacent rack stringers of a pair of rack stringers of the pairs of rack stringers, the pallet supports being located opposite one another at a mutual distance in the horizontal direction, and
wherein a number of storage pallets that is required for the production process is configured to be provided for the pallet storage unit;
a pallet transferer by which the storage pallets can be transferred between a production-side position located towards the production device and a storage-side position,
wherein the storage pallets are stored in the storage-side position on the pallet supports of a pallet storage location in each case and define the storage height of a pallet storage location as a clear vertical distance between two storage pallets that are adjacent to each other in the storage-side position in the vertical direction or as the clear vertical distance between a storage pallet and another boundary of the pallet storage location that is adjacent to it in the vertical direction,
wherein the pallet storage unit is configured by the storage pallets in a manner adapted to the production process carried out on the mechanical production device, and
wherein an existing configuration of the pallet storage unit is configured to be changed into a new configuration of the pallet storage unit by changing the storage height of at least one pallet storage location by changing the number of storage pallets of the pallet storage unit; and
a pallet supply,
to which storage pallets are configured be transferred that are required for the existing configuration of the pallet storage unit and that are not required for the new configuration of the pallet storage unit, and/or from which storage pallets stored in the pallet supply are configured to be removed that are required for the new configuration of the pallet storage unit in addition to the storage pallets required for the existing configuration of the pallet storage unit.

9. The mechanical production plant according to claim 8, wherein the storage pallets are configured partly as raw parts pallets for starting workpieces and partly as product pallets for machining products, and
wherein the raw parts pallets and the product pallets are identical in construction.

10. The mechanical production plant according to claim 8, comprising a mechanical pallet transport, by which:
the storage pallets required for the existing configuration of the pallet storage unit and not required for the new configuration of the pallet storage unit are configured to be transferred to the pallet supply, and/or the storage pallets required for the new configuration of the pallet storage unit, in addition to the storage pallets required for the existing configuration of the pallet storage unit, are configured to be removed from the pallet supply for provision for the production process.

11. The mechanical production plant according to claim 10, wherein the pallet supply is arranged away from the storage rack of the pallet storage unit,
wherein the pallet transferer has a rack-side transfer unit and a production-side transfer unit,
wherein, by the rack-side transfer unit of the pallet transferer, storage pallets are configured to be arranged in the storage rack of the pallet storage unit in the storage-side position or are configured to be removed from the storage rack of the pallet storage unit and arranged in a transfer position outside the storage rack,
wherein, by the production-side transfer unit of the pallet transferer, storage pallets are configured to be transferred between the transfer position and the mechanical production device, and
wherein the production-side transfer unit of the pallet transferer forms the mechanical pallet transport.

12. The mechanical production plant according to claim 8, wherein a programmable numerical control is provided for the pallet transferer and/or for the mechanical pallet transport, by which the pallet transferer and/or the mechanical pallet transport is configured to be controlled to carry out the configuration of the pallet storage in a manner adapted to the production process.
